(19) United States
(12) Patent Application Publication
(10) Pub. No.: US 2012/0024744 A1
(43) Pub. Date: Feb. 2, 2012

(54) Soil-related and/or Crop-related Applications for Chlorine Dioxide

(75) Inventors: Ken Harrison, Madison, VA (US); Robert A. Cooke, Afton, VA (US); Nick Blandford, Charlottesville, VA (US)

(73) Assignee: DHARMA IP, LLC, Charlottesville, VA (US)

(21) Appl. No.: 13/191,738

(22) Filed: Jul. 27, 2011

Related U.S. Application Data
(60) Provisional application No. 61/368,072, filed on Jul. 27, 2010.

(51) Int. Cl. B65D 85/84; A01P 1/00; A01C 11/00; A01N 59/00

(52) U.S. Cl. 206/524.1; 424/661; 504/101; 111/100

(57) ABSTRACT

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, introducing chlorine dioxide to soil and/or planting a crop in the soil.

### CROSS-REFERENCES TO RELATED APPLICATIONS

This application claims priority to pending U.S. Provisional Patent Application 61/368,072 (Attorney Docket 1099-039), filed 27 Jul. 2010.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 graphs chlorine dioxide concentration versus time for a series of polymer gels for Example 3;

FIG. 2 graphs chlorine dioxide concentration versus time for a series of polymer gels for Example 4;

FIG. 3 is a block diagram of an exemplary embodiment of a method 3000;

FIG. 4 is a graph of an exemplary embodiment's ability to retain ClO2;

FIG. 5 is a graph of an exemplary embodiment's ability to retain ClO2;

FIG. 6 is a table describing specifics of individual examples;

FIG. 7 is a flowchart of an exemplary embodiment of a method 7000; and

FIG. 8 is a flowchart of an exemplary embodiment of a method.

### DESCRIPTION

Pure chlorine dioxide can be produced by the system and/or method described in U.S. Pat. Nos. 5,855,861 (the '861 patent) and/or 6,051,135 (the '135 patent).

Broadly, certain exemplary gel and solid gel compositions can be made by absorbing substantially byproduct-free and FAC-free, pure aqueous chlorine dioxide solution in a superabsorbent or water-soluble polymer that is nonreactive with chlorine dioxide in a substantially oxygen-free environment. As tested thus far, product gel retains the chlorine dioxide concentration at 80% or higher for at least 6 months at room temperature.

Certain exemplary gel and solid gel compositions retain chlorine dioxide molecules in an inert and innocuous solid matrix such as a gel or tablet. Such a matrix can limit the mobility of the thus-entrapped molecules, making them less susceptible to mechanical shock, protects against UV or IR radiation, and limits air/oxygen penetration. The gel typically should not have microbubbles or air globules present, and preferably the amount of polymer material required should be sufficiently small so as to make the resulting product cost-effective. Any decomposition that does occur should preferably yield only harmless chloride ion and oxygen. For example:

ClO₂(aq. gel)+organics, impurities→ClO₂⁻(aq. gel)

ClO₂⁻(aq. gel)→Cl⁻+O₂

The composition may also comprise a tablet in an alternate embodiment of a solid gel composition. Such a tablet is created by substantially the same method as for the gel; however, a greater proportion of the superabsorbent polymer is used, e.g., ˜50 wt. %, with ˜50 wt. % ClO2 solution added.

The superabsorbent polymer should not be able to undergo an oxidation reaction with chlorine dioxide, and should be able to liberate chlorine dioxide into water without any mass transfer resistance. Nor should byproduct be releasable from the gel in contact with fresh water. Exemplary polymers may comprise at least one of a sodium salt of poly(acrylic acid), a potassium salt of poly(acrylic acid), straight poly(acrylic acid), poly(vinyl alcohol), and other types of cross-linked polyacrylates, such as polyacrylimide and poly(chloro-trimethylaminoethyl acrylate), each being preferably of pharmaceutical grade. It is believed that sodium salts are preferable to potassium salts for any potential byproduct release, although such a release has not been observed. The amount of polymer required to form a stable gel is in the order of sodium and potassium salts of poly(acrylic acid)<straight poly(acrylic acid)<poly(vinyl alcohol). The order of stability is in reverse order, however, with very little difference among these polymer types.

### Molecular Matrix-Residing Chlorine Dioxide—Gels

The gel can be formed by mixing a mass of the polymer into the aqueous chlorine dioxide solution in an amount preferably less than 5-10%, most preferably in range of approximately 0.5-5%, and stirring sufficiently to mix the components but sufficiently mildly so as to minimize the creation of agitation-produced bubbles. Gelling efficiency varies among the polymers, with the poly(acrylic acid) salts (Aridall and ASAP) forming gels more quickly with less polymer, a ratio of 100:1 solution:resin sufficient for making a stable gel; straight poly(acrylic acid) requires a ratio of 50:1 to make a similarly stable gel. The stabilities here refer to mechanical and structural, not chemical, stability.

The gelling process typically takes about 0.5-4 min, preferably 2 min, with a minimum time of mixing preferable. Gels can be produced without mixing; however, mild agitation assists the gelling process and minimizes gelling time. It has been found that 1 g of polymer can be used with as much as 120 g of 2000-ppm pure chlorine dioxide solution. Concentrations of at least 5000 ppm are achievable.

Any bubbles that are produced are found to be very stable, taking 2-3 weeks to migrate to the top of a container, which is 6-7 orders of magnitude slower than bubbles in an aqueous chlorine dioxide solution.

Preferably the mixing is carried out in a substantially air/oxygen-free environment in a closed container, possibly nitrogen-purged. Storage of the formed gel should be in sealed containers having UV-blocking properties is preferred, such containers comprising, for example, UV-blocking amber glass, opaque high-density polyethylene, chlorinated poly(vinyl chloride) (CPVC), polytetrafluoroethylene(PTFE)-lined polyethylene, cross-linked polyethylene, polyvinyl chloride, and polyvinylidenefluoride (PVDF), although these are not intended to be limiting.

The gel was found to be very effective in preserving chlorine dioxide concentration for long periods of time, in sharp contrast to the 1-2 days of the aqueous solution. The clean, color of the gel is retained throughout storage, and did not substantially degas as found with aqueous solutions of similar concentration. For example, a 400-ppm aqueous solution produces a pungent odor that is not detectable in a gel of similar concentration. The straight PAA gels made from Carbopol (Polymer C; Noveon, Inc., Cleveland, Ohio) were found to achieve better preservation than the PAA salt types. Additional resins that may be used include, but are not intended to be limited to, Aridall and ASAP (BASF Corp., Charlotte, N.C.), and poly(vinyl alcohol) (A. Schulman, Inc., Akron, Ohio).

The liberating of aqueous chlorine dioxide from the gel material is performed by stirring the gel material into deionized water, and sealing and agitating the mixing vessel, for example, for 15 min on a low setting. Polymer settles out in approximately 15 min, the resulting supernatant comprising substantially pure aqueous chlorine dioxide. The gellant is recoverable for reuse.

Aqueous chlorine dioxide is liberated from a tablet by dissolving the tablet into deionized water and permitting the polymer to settle out as a precipitate.

The resulting aqueous chlorine dioxide may then be applied to a target, such as, but not intended to be limited to, water, wastewater, or a surface.

In order to minimize decomposition, both spontaneous and induced, the components of the gel and solid gel composition should be substantially impurity-free. Exposure to air/oxygen and UV and IR radiation should be minimized, as should mechanical shock and agitation.

Laboratory data are discussed in the following four examples.

### Example 1

Two types of polymer, the sodium and potassium salts of poly(acrylic acid), were used to form gels. The aqueous chlorine dioxide was prepared according to the method of the '861 and '135 patents, producing a chlorine dioxide concentration of 4522 mg/L, this being diluted as indicated.

The gels were formed by mild shaking for 2 min in an open clock dish, the gels then transferred to amber glass bottles, leaving minimum headspace, sealed, and stored in the dark. The aqueous controls were stored in both clear and amber bottles. After 3 days it was determined that the gels retained the original color and consistency, and were easily degelled. Table 1 provides data for 3 and 90 days, illustrating that little concentration loss occurred. The samples after 3 days were stored under fluorescent lighting at approximately 22° C.

TABLE 1
Chlorine Dioxide Gels in 3- and 90-Day Storage, Concentrations in ppm

| | | ClO2 | Polymer | Initial | ClO2 Conc. | ClO2 | |
|---|---|---|---|---|---|---|---|
| | | Amt. | Amt. | ClO2 | After 3 | Conc. After | Prod. |
| | Container | (ml) | (g) | Conc. | Days | 90 Days | Form |
| Aqueous Soln. | Clear Bottle | 35 | — | ~420 | ~60 | ~0 | Soln. |
| Aqueous Soln. | Amber Bottle | 35 | — | ~420 | ~370 | ~70 | Soln. |
| Polymer BA1-1 | Amber Bottle | 35 | 0.25 | ~400 | ~390 | ~380 | Gel |
| Polymer BA1-2 | Amber Bottle | 35 | 0.30 | ~380 | ~350 | ~350 | Gel |
| Polymer BA2-1 | Amber Bottle | 35 | 0.25 | ~380 | ~350 | ~330 | Gel |
| Polymer BA2-2 | Amber Bottle | 35 | 0.30 | ~380 | ~360 | ~355 | Gel |

BA1: Sodium polyacrylate ASAP ™ (BASF)
BA2: Potassium polyacrylate, Aridall ™ (BASF)

From these data it may be seen that, even when stored in a tightly sealed, amber bottle, the aqueous solution loses strength rapidly, although the amber bottle clearly provides some short-term alleviation of decomposition.

Also, even with a 0.71% proportion of gelling material, a stable gel was formed. The gels, in the order presented in Table 1, retained 97.4, 100, 94.3, and 98.6% of their strength at 3 days after 90 days. The two polymers provided essentially equal effectiveness. The gels apparently protected against UV-mediated decomposition. The gels are also far more effective in preserving chlorine dioxide concentration.

The gels were shown to preserve their original color during the storage period. Analysis after 90 days proved that the degelled solution contained only chlorine dioxide and a very small amount of chloride ion.

### Example 2

Gels formed by five different polymers, each having their formed gels stored in clear and amber containers, were compared when stored under different conditions. Table 2 provides the results of these experiments.

TABLE 2
Results of Experiments of Example 2

| | # of Days | | | | | | | |
|---|---|---|---|---|---|---|---|---|
| | 10 | 14 | 21 | 28 | 32 | 39 | 51 | 102 |
| CONTROL 1 | 407 | 414 | 380 | 332 | 312 | 282 | 288 | 277 |
| STDEV | 0.0 | 11.7 | 12 | 5.9 | 11.7 | 5.9 | 5.9 | 6.6 |
| CONTROL 2 | 332 | 271 | 278 | 261 | 265 | 292 | 282 | 280 |
| STDEV | 11.7 | 23.5 | 12 | 5.9 | 10.2 | 11.7 | 15.5 | 10.0 |
| CONTROL 3 | 286 | 241 | 229 | 225 | 221 | 233 | 225 | 219 |
| STDEV | 0.0 | 0.0 | 0.0 | 6.6 | 6.6 | 6.6 | 6.6 | 5.9 |
| HALF | 331 | 292 | 280 | 235 | 254 | 263 | 205 | 144 |
| BOTTLE | | | | | | | | |
| STDEV | 25.7 | 11.6 | 9 | 10.4 | 10.2 | 12.6 | 7.8 | 7.1 |
| Polymer A | 257 | 248 | 236 | 214 | 208 | 208 | 201 | 197 |
| STDEV | 12.8 | 7.4 | 7 | 14.8 | 6.4 | 9.8 | 7.4 | 8.8 |
| Polymer B | 228 | 216 | 208 | 196 | 198 | 194 | 192 | 184 |
| STDEV | 0.0 | 0.0 | 7 | 6.9 | 12.0 | 6.9 | 12.0 | 6.5 |
| Polymer C-1 | 317 | 283 | 278 | 266 | 270 | 278 | 270 | 271 |
| STDEV | 7.4 | 12.8 | 7 | 7.4 | 11.1 | 7.4 | 12.9 | 10.2 |
| Polymer C-2 | 287 | 291 | 287 | 261 | 257 | 259 | 257 | 254 |
| STDEV | 7.4 | 7.4 | 7 | 7.4 | 0.0 | 3.7 | 0.0 | 4.9 |
| PPM lost due | 46 | 31 | 49 | 36 | 43 | 59 | 56 | 61 |
| to separation | | | | | | | | |
| of polymer | | | | | | | | |
| (CONTROL | | | | | | | | |
| 2 − | | | | | | | | |
| CONTROL 3) | | | | | | | | |
| Average = 48 | | | | | | | | |

CONTROL 1: Full amber bottle with polymer (no agitation)
CONTROL 2: Full amber bottle prepared with polymer samples (agitated for 15 min)
CONTROL 3: Full amber bottle prepared with polymer samples (agitated for 15 min) and analyzed with polymer samples (diluted and agitated for 15 min)
HALF: Half-filled amber bottle
POLYMER A: Sodium polyacrylate, ASAP (BASF); full amber bottle with 0.25 g ASAP (agitated 15 min for preparation and diluted and agitated 15 min for analysis)
POLYMER B: Potassium polyacrylate; full amber bottle with 0.30 g Aridall (BASF) (agitated 15 min for preparation and diluted and agitated 15 min for analysis)
CARBOPOL C-1: Poly(acrylic acid); full amber bottle with 0.50 g Carbopol ® 974 (Noveon)(agitated 15 min for preparation and diluted and agitated 15 min for analysis)
CARBOPOL C-2: Poly(acrylic acid); Full amber bottle with 0.75 g Carbopol ® 971 (Noveon)(agitated 15 min for preparation and diluted and agitated 15 min for analysis

The half-bottle results indicate that stability was significantly lower than in full-bottle samples under substantially identical preparation and storage conditions, the difference being even more pronounced with longer storage times, illustrating the decomposition effect triggered by gas-phase air. Even in the half-bottle gels, however, storage effectiveness is still 100-200 times that of conventional solution storage.

### Example 3

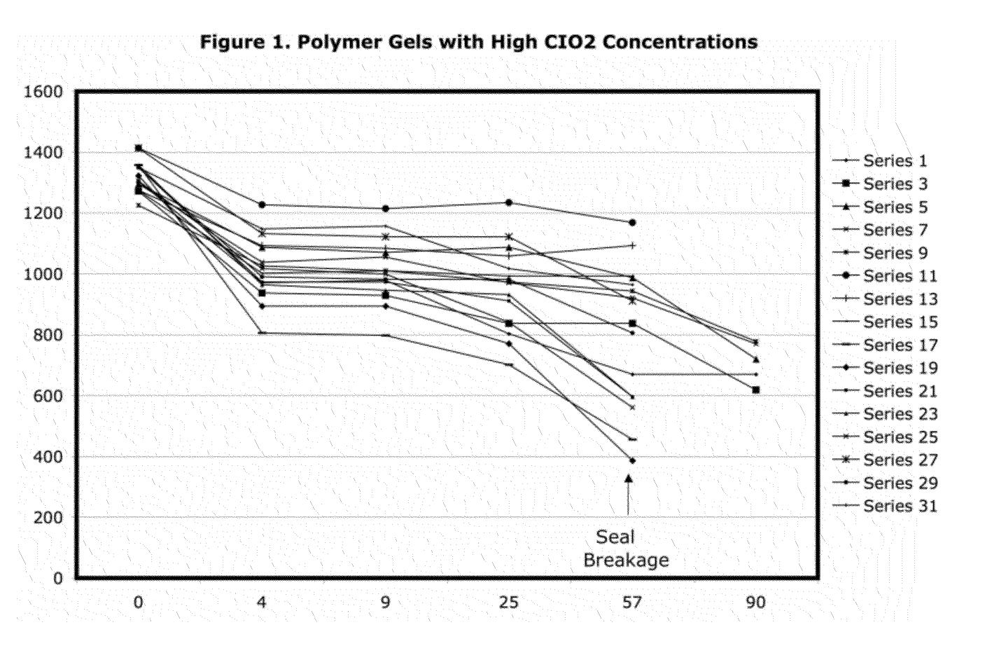

High-concentration (1425 ppm) aqueous chlorine dioxide was used to form polymer gels as listed in Table 3 in this set of experiments, the results of which are given in Table 4 and FIG. 1. The initial loss of concentration strength is due to dilution and procedural exposure, during preparation and analysis, to ambient air, not to decomposition based upon interaction between the polymer and the chlorine dioxide.

TABLE 3
Sample Preparation for Gel Technology (High Concentration)

| Samples | Bottle | Gellant |
|---|---|---|
| HDA | Amber | Polymer A |
| HDB | Amber | Polymer B |
| HDC | Amber | Polymer C-1 |
| HDD | Amber | Polymer C-2 |
| HDE | Amber | Polymer C-3 |
| HDF | Amber | Control 1 |
| HDG | Amber | Control 2 |
| HDH | Clear | Control 3 |
| HDI | Clear | Polymer A |
| HDJ | Clear | Polymer B |
| HDK | Clear | Polymer C-1 |
| HDL | Clear | Polymer C-2 |
| HDM | Clear | Polymer C-3 |
| HDN | Clear | Control 1 |
| HDO | Clear | Control 2 |
| HDP | Clear | Control 3 |

Note: All sample bottles are full, and stored at room temperature under fluorescent light.

TABLE 4
ClO2 Analysis Data of ClO2 Gels

| | TRT | Initial | 4 d | 9 d | 25 d | 57 d | 90 d | Series |
|---|---|---|---|---|---|---|---|---|
| HDA | 1425 | 1306 | 971 | 979 | 803 | 670 | 670 | 1 |
| | | 0 | 24 | 12 | 0 | 0 | 0 | |
| HDB | 1425 | 1272 | 937 | 929 | 837 | 837 | 619 | 3 |
| | | 0 | 0 | 12 | 00 | 0 | 24 | |
| HDC | 1425 | 1297 | 1088 | 1071 | 1088 | 988 | 720 | 5 |
| | | 12 | 24 | 0 | 24 | 24 | 24 | |
| HDD | 1425 | 1297 | 1038 | 1055 | 971 | 921 | 770 | 7 |
| | | 12 | 47 | 0 | 0 | 24 | 47 | |
| HDE | 1425 | 1225 | 1026 | 1010 | 973 | 944 | 778 | 9 |
| | | 0 | 0 | 23 | 0 | 23 | 23 | |
| HDF | 1425 | 1414 | 1227 | 1215 | 1234 | 1169 | | 11 |
| | | 17 | 17 | 0 | 0 | 0 | | |
| HDG | 1425 | 1275 | 1093 | 1084 | 1059 | 1093 | | 13 |
| | | 23 | 0 | 12 | 0 | 0 | | |
| HDH | 1425 | 1275 | 1002 | 1010 | 993 | 993 | | 15 |
| | | 23 | 12 | 23 | 0 | 0 | | |
| HDI | 1425 | 1358 | 806 | 798 | 701 | 456 | | 17 |
| | | 12 | 0 | 12 | 0 | 0 | | |
| HDJ | 1425 | 1323 | 894 | 894 | 771 | 386 | | 19 |
| | | 12 | 25 | 25 | 0 | 50 | | |
| HDK | 1425 | 1350 | 973 | 973 | 911 | 596 | | 21 |
| | | 0 | 12 | 12 | 0 | 0 | | |
| HDL | 1425 | 1358 | 964 | 946 | 932 | 596 | | 23 |
| | | 12 | 25 | 0 | 0 | 0 | | |
| HDM | 1425 | 1306 | 1017 | 999 | 841 | 561 | | 25 |
| | | 12 | 0 | 25 | 0 | 0 | | |
| HDN | 1425 | 1414 | 1133 | 1122 | 1122 | 911 | | 27 |
| | | 17 | 17 | 0 | 0 | 33 | | |
| HDO | 1425 | 1350 | 990 | 982 | 982 | 806 | | 29 |
| | | 25 | 12 | 0 | 0 | 0 | | |
| HDP | 1425 | 1350 | 1148 | 1157 | 1017 | 964 | | 31 |
| | | 25 | 12 | 0 | 0 | 25 | | |

Note:
Data in the first row for each sample are averages, while those on the second row are standard deviations. Sample designations as in Table 3.

The data indicate that the gels are quite stable for a long period of time. In most cases the gels retained their strength at 50% or higher even after 90 days, which is believed to represent a technological breakthrough.

Amber bottles are clearly more effective in preserving chlorine dioxide concentration, especially until the 60-day mark. Some late-stage decline may be attributable to seal failure, the seals used in these experiments comprising paraffin, which is known to be unreliable with regard to drying, fracture, pyrolytic evaporation, and puncture, and some of this failure was observable to the naked eye.

The high-molecular-weight polymer, poly(acrylic acid) (polymer C) was more effective than its lower-molecular-weight counterparts, the PAA salts (polymers A and B), indicating that higher-molecular-weight polymers provide better structural protection and “caging” for chlorine dioxide molecules against UV and air.

### Example 4

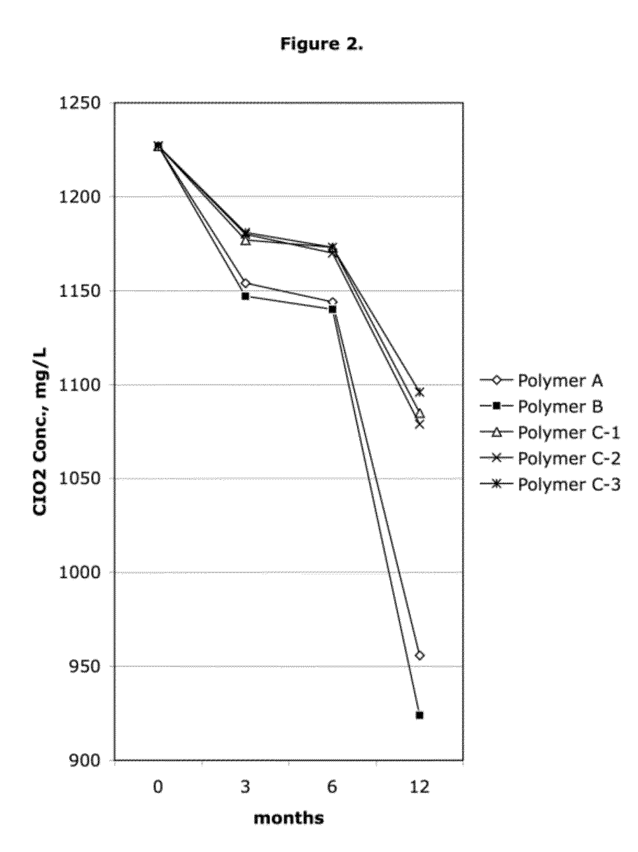

The long-term stability of the gels was tested using a set of gels prepared from three different types of water-soluble polymers. The prepared samples were kept in a ventilated cage with fluorescent light on full-time at room temperature. The gel samples were sealed tightly in amber bottles with paraffinic wax and wrapped with Teflon tapes for additional protection. Five identical samples using each polymer type were prepared, and one each was used for analysis at the time intervals shown in Table 5 and FIG. 2.

TABLE 5
Long-term Stability of Chlorine Dioxide Gels

| | 0 mo. | 3 mo. | 6 mo. | 12 mo. |
|---|---|---|---|---|
| Polymer A | 1227 | 1154 | 1144 | 956 |
| Polymer B | 1227 | 1147 | 1140 | 924 |
| Polymer C-1 | 1227 | 1177 | 1173 | 1085 |
| Polymer C-2 | 1227 | 1180 | 1170 | 1079 |
| Polymer C-3 | 1227 | 1181 | 1173 | 1096 |

Polymers A and B were added at 0.8% of the solution mass, with Polymer C added at 2%, to achieve optimal gelling concentration for each individual polymer.

All the samples indicate long-term chlorine dioxide product stability previously unachievable in the art. The gels made from polymer C were better in long-term preservation of chlorine dioxide than those made using polymers A and B, which may be attributable to its higher average molecular weight, as well as to the greater amount of polymer used per unit volume.

Therefore, it will be appreciated by one of skill in the art that there are many advantages conferred by the described embodiments. Chlorine dioxide can be preserved at least 200, and up to 10,000, times longer than previously possible in aqueous solution. Off-site manufacturing and transport now becomes possible, since the composition can be unaffected by vibration and movement, can be resistant to UV and IR radiation, to bubble formation, and to oxygen penetration, and can reduce vapor pressure. The composition can have substantially reduced risks from inhalation and skin contact.

The applications of the described embodiments are numerous in type and scale, and may include, but are not intended to be limited to, industrial and household applications, and medical, military, and agricultural applications. Specifically, uses may be envisioned for air filter cartridges, drinking water, enclosed bodies of water, both natural and manmade, cleansing applications in, for example, spas, hospitals, bathrooms, floors and appliances, tools, personal hygiene (e.g., for hand cleansing, foot fungus, gingivitis, soaps, and mouthwash), and food products. Surfaces and enclosed spaces may be cleansed, for example, against gram-positive bacteria, spores, and anthrax.

### Molecular Matrix-Residing Chlorine Dioxides—Solids

Chlorine dioxide (“ClO2 ”) can be an excellent disinfectant, and/or can be effective against a wide range of organisms. For example, ClO2 can provide excellent control of viruses and bacteria, as well as the protozoan parasites Giardia, Cryptosporidium, and/or amoeba Naegleria gruberi and their cysts.

In addition to disinfection, ClO2 can have other beneficial uses in water treatment, such as color, taste and odor control, and removal of iron and manganese. There are also important uses outside of water treatment, such as bleaching pulp and paper (its largest commercial use), disinfection of surfaces, and sanitization/preservation of fruits and vegetables.

ClO2 can present certain challenges, which can stem largely from its inherent physical and chemical instability. ClO2 in pure form is a gaseous compound under normal conditions. As a gas, it can be sensitive to chemical decomposition, exploding at higher concentrations and when compressed. Because ClO2 can be highly soluble in water, ClO2 can be used as a solution of ClO2 gas dissolved in water.

However, the gaseous nature of ClO2 means that it can be volatile, thus ClO2 tends to evaporate rapidly from solutions when open to the atmosphere (physical instability). This tendency can limit the practically useful concentrations of ClO2 solutions. With concentrated solutions, this rapid evaporation can generate gaseous ClO2 concentrations that can present an unpleasantly strong odor, and can pose an inhalation hazard to users. A closed container of the solution can quickly attain a concentration in the headspace of the container that is in equilibrium with the concentration in the solution. A high concentration solution can have an equilibrium headspace concentration that exceeds the explosive limits in air (considered to be about 10% by volume in air).

For these and other reasons, virtually all commercial applications to date have required that ClO2 be generated at the point of use to deal with these challenges. However, on-site generation also can have significant draw-backs, particularly in the operational aspects of the equipment and the need to handle and store hazardous precursor chemicals. It can be desirable to have additional forms of ready-made ClO2.

Certain exemplary embodiments can provide a composition of matter comprising a solid form of chlorine dioxide complexed with a cyclodextrin. When stored, a concentration of the chlorine dioxide in the composition of matter can be retained at, for example, greater than 12% for at least 14 days and/or greater than 90% for at least 80 days, with respect to an initial concentration of chlorine dioxide in said composition of matter. Certain exemplary embodiments can provide a method comprising releasing chlorine dioxide from a solid composition comprising chlorine dioxide complexed with a cyclodextrin.

Certain exemplary embodiments can provide a solid complex formed by combining ClO2 with a complexing agent such as a cyclodextrin, methods of forming the complex, and/or methods of using the complex as a means of delivering ClO2, such as essentially instantly delivering ClO2.

ClO2 is widely considered to be inherently unstable. Also, ClO2 is widely considered to be reactive with a fairly wide range of organic compounds, including glucose, the basic building block of cyclodextrins such as alpha-cyclodextrin. It is reasonable to assume that ClO2 will react with cyclodextrins in solution. Additionally, relatively impure ClO2 systems containing chlorite and/or chlorate impurities might be expected to destroy cyclodextrins due to the reactivity of chlorite/chlorate with organic compounds.

Chlorine dioxide can be generated by the method described in the OxyChem Technical Data Sheet “Laboratory Preparations of Chlorine Dioxide Solutions—Method II: Preparation of Reagent-Grade Chlorine Dioxide Solution”, using nitrogen as the stripping gas.

That method specifies the following equipment and reagents:
three-neck reaction flask, 1-liter (1)
pressure equalizing addition funnel, 125-mls (2)
gas inlet tube, with adapter (3)
gas exit adapter (4)
gas scrubbing tower, 1-liter (5)
amber reagent bottle, 1 liter (6)
gas inlet tube, without adapter (7)
ice bath (8)
flexible tubing (rubber or Tygon®)
Technical Sodium Chlorite Solution 31.25
concentrated sulfuric acid, 36N

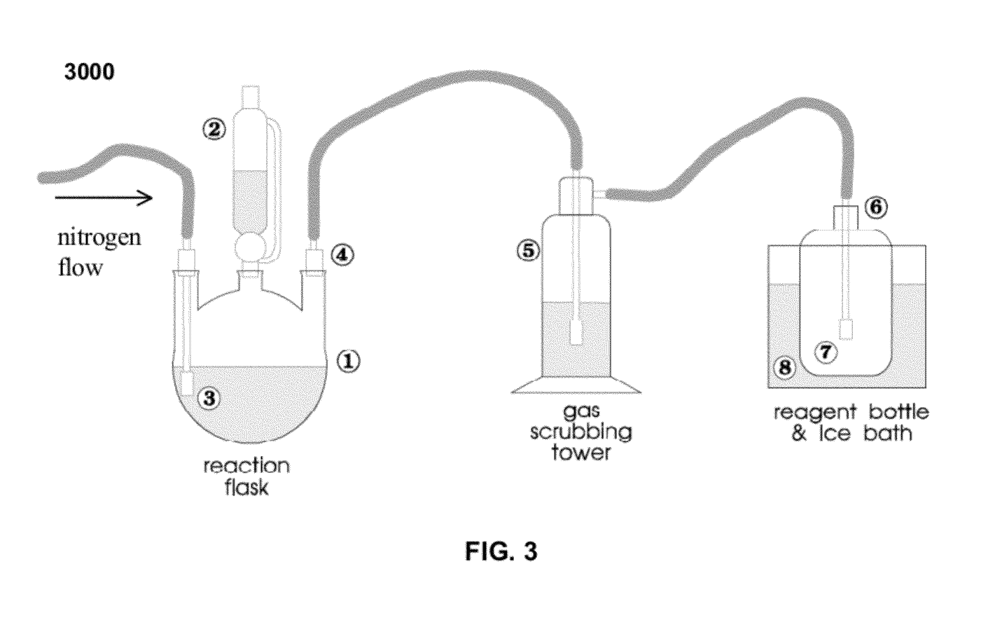

That method specifies, inter alia, the following procedure:
Assemble the generator setup as shown in FIG. 3. To ensure airtight assembly use standard taper glassware and silicon grease if possible. Rubber stoppers are an acceptable alternative.
Fill the reaction flask and gas scrubbing tower with 500 mls of approximately 2.5% (wt) NaClO2 solution. Make certain all gas inlets are submerged. (2.5% NaClO2 solution may be prepared by diluting OxyChem Technical Sodium Chlorite Solution 31.25 1:10 with DI water).
Prepare 50 mls of 10% (vol) sulfuric acid solution and place this solution in the addition funnel. WARNING: Always add acid to water; never add water to acid.
Fill the amber reagent bottle with 500 to 750 mls. of DI water and place in an ice bath.
Turn on the air flow to the generation setup (there should be bubbles in all three solutions.) If there are not, check the setup for leaks.
Once there are no leaks, slowly add the acid solution (5 to 10 mls at a time). Wait minutes between additions. Continue the air flow for 30 minutes after the final addition.
Store the chlorine dioxide solution in a closed amber bottle in a refrigerator.

Properly stored solutions may be used for weeks, but should be standardized daily, prior to use, by an approved method, such as Method 4500-ClO2, Standard Methods for the Examination of Water and Wastewater., 20th Ed., APHA, Washington, D.C., 1998, pp 4-73 to 4-79.

We have unexpectedly discovered that, by bubbling sufficiently pure gaseous ClO2 diluted in nitrogen (as generated by this method) at a rate of, for example, approximately 100 ml/minute to approximately 300 ml/minute, through a near-saturated solution of alpha-cyclodextrin (approximately 11% to approximately 12% w/w) in place of plain water, at or below room temperature, a solid precipitate formed. The minimum ClO2 concentration required to obtain the solid precipitate lies somewhere in the range of approximately 500 ppm to approximately 1500 ppm. A 1:1 molar ratio of ClO2 to cyclodextrin—approximately 7600 ppm ClO2 for approximately 11% alpha-cyclodextrin—is presumed to be needed in order to complex all the alpha-cyclodextrin. We believe that the use of even more ClO2 will maximize the amount of precipitate that forms. Precipitation may begin before ClO2 addition is complete, or may take up to approximately 2 to approximately 3 days, depending on the amount of ClO2 added and the temperature of the system.

Another method of preparing this solid material is as follows. A solution of alpha-cyclodextrin is prepared. That solution can be essentially saturated (approximately 11%). A separate solution of ClO2 can be prepared by the method referenced above, potentially such that it is somewhat more concentrated than the alpha-cyclodextrin solution, on a molar basis. Then the two solutions can be combined on approximately a 1:1 volume basis and mixed briefly to form a combined solution. Concentrations and volumes of the two components can be varied, as long as the resultant concentrations in the final mixture and/or combined solution are sufficient to produce the precipitate of the complex. The mixture and/or combined solution then can be allowed to stand, potentially at or below room temperature, until the precipitate forms. The solid can be collected by an appropriate means, such as by filtration or decanting. The filtrate/supernatant can be chilled to facilitate formation of additional precipitate. A typical yield by this unoptimized process, after drying, can be approximately 30 to approximately 40% based on the starting amount of cyclodextrin. The filtrate/supernatant can be recycled to use the cyclodextrin to fullest advantage.

The collected precipitate then can be dried, such as in a desiccator at ambient pressure, perhaps using Drierite™ desiccant. It has been found that the optimum drying time under these conditions is approximately 24 hours. Shorter drying times under these conditions can leave the complex with unwanted free water. Longer drying times under these conditions can result in solid containing a lower ClO2 content.

Since we have observed that the residence time of the complex in a desiccating chamber has a distinct effect on the resulting ClO2 content of the dried complex, it is expected that the use of alternate methods of isolating and/or drying the complex can be employed to alter yield rates and obtain a ClO2 cyclodextrin complex with specific properties (stability, ClO2 concentration, dissolution properties, etc.) suitable for a particular application. Lyophilization and spray-drying are examples of these kinds of alternate methods, which can dry the precipitated complex, and/or isolate the complex as a dry solid from solution-phase complex, and/or from the combined precipitate/solution mixture.

Based on methods used to form other complexes with cyclodextrins, it is believed that any of several additional methods could be utilized to form the ClO2 cyclodextrin complex. Slurry complexation, paste complexation, solid phase capture, and co-solvent systems are examples of additional preparatory options. In one unoptimized example of a modified slurry process, 11 g of solid alpha-cyclodextrin was added directly to a 100 g solution of 7800 ppm ClO2 and mixed overnight. While a majority of the cyclodextrin went into solution, approximately 20% of the powder did not. This was subsequently found to have formed a complex with ClO2 that upon isolation, contained approximately 0.8% ClO2 by weight. In one unoptimized example of a solid phase capture process, ClO2 gas was generated by the method described in the OxyChem Technical Data Sheet. The ClO2 from the reaction was first passed through a chromatography column packed with a sufficient amount of Drierite to dry the gas stream. Following this drying step, 2.0 g of solid alpha-cyclodextrin was placed in-line and exposed to the dried ClO2 in the vapor phase for approximately 5 hours. The alpha-cyclodextrin was then removed, and found to have formed a complex with ClO2 containing approximately 0.75% ClO2 by weight.

This precipitate is assumed to be a ClO2/alpha-cyclodextrin complex. Cyclodextrins are known to form complexes or “inclusion compounds” with certain other molecules, although for reasons presented above it is surprising that a stable complex would form with ClO2. Such a complex is potentially characterized by an association between the cyclodextrin molecule (the “host”) and the “guest” molecule which does not involve covalent bonding. These complexes are often formed in a 1:1 molecular ratio between host and guest, but other ratios are possible.

There are a number of reaction conditions that affect the process leading to the formation of the complex. Any of these conditions can be optimized to enhance the yield and/or purity of the complex. Several of these conditions are discussed below.

The pH at which the complexation takes place between ClO2 and cyclodextrin has been observed to affect the yield and ClO2 content of the resulting ClO2 complex. Therefore, this parameter might affect the stability and/or properties of the resulting complex. An approximately 11% alpha-cyclodextrin solution was combined with an approximately 9000 ppm ClO2 solution on a 1:1 molar basis and the pH immediately adjusted from approximately 3.5 to approximately 6.7 with approximately 10% NaOH. A control was set up in the same fashion with no pH adjustment after combining the approximately 11% cyclodextrin and approximately 9000 ppm ClO2 solution. The resulting yield of the pH adjusted preparation was approximately 60% lower than the control and had approximately 20% less ClO2 content by weight.

The temperature at which the complexation takes place between ClO2 and cyclodextrin has been observed to affect the yield and ClO2 content of the resulting ClO2 complex. Therefore, this parameter might affect the stability and/or properties of the resulting complex. An approximately 11% alpha-cyclodextrin solution was combined with an approximately 7800 ppm ClO2 solution on a 1:1 molar basis in 2 separate bottles. One of these was placed in a refrigerator at approximately 34° F. and the other was left at room temperature. Upon isolation and dry down of the resulting complexes, the refrigerated preparation produced approximately 25% more complex by weight and a lower ClO2 concentration.

The stirring rate and/or level of agitation during the formation of a ClO2 cyclodextrin complex has been observed to affect the yield and ClO2 content of the resulting ClO2 complex. Therefore, this parameter might affect the stability and/or properties of the resulting complex. An approximately 11% alpha-cyclodextrin solution was combined with an approximately 7800 ppm ClO2 solution on a 1:1 molar basis in 2 separate bottles. One of the bottles was placed on a magnetic stir plate at approximately 60 rpm, while the other remained undisturbed. After approximately 5 days, the precipitated complex from each was isolated and dried down. The preparation that was stirred resulted in an approximately 20% lower yield and approximately 10% lower ClO2 concentration by weight.

The addition of other compounds to the complexation mixture has been observed to affect the yield and/or ClO2 content of the resulting ClO2 complex. Therefore, the use of additives in the preparation process might affect the stability and/or properties of the resulting complex and/or lead to a ClO2 complex with properties tailored to a specific application. For example, we have found that very low concentrations of water soluble polymers (approximately 0.1% w/v), such as polyvinylpyrrolidone and carboxymethylcellulose, have resulted in ClO2 concentrations higher and lower, respectively, than that observed in a control preparation containing only cyclodextrin and ClO2. In both cases however, the yield was approximately 10% lower than the control. In another example, we found that the addition of approximately 0.5% acetic acid to the complexation mixture resulted in approximately 10% higher yield and approximately 40% lower ClO2 content.

When isolated and dried, the resulting solid typically has a granular texture, appears somewhat crystalline, with a bright yellow color, and little or no odor. It can be re-dissolved in water easily, and the resulting solution is yellow, has an odor of ClO2, and assays for ClO2. The ClO2 concentration measured in this solution reaches its maximum as soon as all solid is dissolved, or even slightly before. The typical assay method uses one of the internal methods of the Hach DR 2800 spectrophotometer designed for direct reading of ClO2. The solution also causes the expected response in ClO2 test strips such as those from Selective Micro Technologies or LaMotte Company. If a solution prepared by dissolving this complex in water is thoroughly sparged with N2 (also known as Nitrogen or N₂), the solution becomes colorless and contains virtually no ClO2 detectable by the assay method. The sparged ClO2 can be collected by bubbling the gas stream into another container of water.

One sample of the dried solid complex was allowed to stand in an uncovered container for approximately 30 hours before being dissolved in water, and appeared to have lost none of its ClO2 relative to a sample that was dissolved in water immediately after drying. Four portions from one batch of solid complex left in open air for periods of time ranging from approximately 0 to approximately 30 hours before being re-dissolved in water all appeared to have about the same molar ratio of ClO2 to alpha-cyclodextrin. Other batches appeared to have somewhat different ratios of ClO2 to alpha-cyclodextrin. This difference may simply reflect differences in sample dryness, but it is known that cyclodextrin-to-guest ratios in other cyclodextrin complexes might vary with differences in the process by which the complex was formed. However, samples of the present complex prepared by an exemplary embodiment tended to contain close to, but to date not greater than, a 1:1 molar ratio of ClO2 to cyclodextrin. That is, their ClO2 content approached the theoretical limit for a 1:1 complex of approximately 6.5% by weight, or approximately 65,000 ppm, ClO2. Assuming that a 1:1 molar ratio represents the ideal form of the pure complex, the ratio of ClO2 to cyclodextrin can be targeted as close to 1:1 as possible, to serve as an efficient ClO2 delivery vehicle. However, solid complexes with a net ClO2 to cyclodextrin ratio of less than 1:1 can be desirable in some cases. (We believe such a material is probably a mixture of 1:1 complex plus uncomplexed cyclodextrin, not a complex with a molar ratio of less than 1:1.)

An aqueous solution of ClO2 having such a high concentration (e.g., approaching approximately 65,000 ppm) can pose technical and/or safety challenges in handling, such as rapid loss of ClO2 from the solution into the gas phase (concentrated and therefore a human exposure risk), and/or potentially explosive vapor concentrations in the headspace of a container in which the solution is contained. The solid appears not to have these issues. Release into the gas phase is relatively slow, posing little exposure risk from the complex in open air. The lack of significant odor can be an important factor in the users' sense of safety and/or comfort in using the solid. For example, a small sample has been left in the open air for approximately 72 hours, with only an approximately 10% loss of ClO2. At such a slow rate, users are unlikely to experience irritation or be caused to feel concern about exposure. Gas-phase ClO2 concentration in the headspace of a closed container of the complex can build up over time, but appears not to attain explosive concentrations. Even solid complex dampened with a small amount of water, so that a “saturated” solution is formed, to date has not been observed to create a headspace ClO2 concentration in excess of approximately 1.5% at room temperature. It is commonly believed that at least a 10% concentration of ClO2 in air is required for explosive conditions to exist.

The freshly-prepared complex is of high purity, since it is obtained by combining only highly pure ClO2 prepared by OxyChem Method II, cyclodextrin, and water. Some cyclodextrins are available in food grade, so the complex made with any of these is suitable for treatment of drinking water and other ingestible materials, as well as for other applications. Other purity grades (technical, reagent, pharmaceutical, etc.) of cyclodextrins are available, and these could give rise to complexes with ClO2 that would be suitable for still other applications.

In certain embodiments, the solid complex can be quickly and conveniently dissolved directly in water that is desired to be treated. Alternatively, the solid can be dissolved, heated, crushed, and/or otherwise handled, processed, and/or treated to form, and/or release from the solid, a solution, such as an aqueous chlorine dioxide solution, and/or another form of ClO2, such as a ClO2 vapor, that then can be used for disinfecting surfaces, solids, waters, fluids, and/or other materials. For example, solutions of ClO2 prepared by dissolving the complex in water, either the water to be treated or an intermediate solution, can be used for any purpose known in the art for which a simple aqueous solution of comparable ClO2 concentration would be used, insofar as this purpose is compatible with the presence of the cyclodextrin. These uses can include disinfection and/or deodorization and/or decolorization of: drinking water, waste water, recreational water (swimming pools, etc.), industrial reuse water, agricultural irrigation water, as well as surfaces, including living tissues (topical applications) and foods (produce, meats) as well as inanimate surfaces, etc.

It is anticipated that the complex can be covalently bound, via the cyclodextrin molecule, to another substrate (a polymer for example) for use in an application where multiple functionality of a particular product is desired. For example, such a complex bound to an insoluble substrate can, upon contact with water, release its ClO2 into solution while the cyclodextrin and substrate remain in the solid phase.

It has been found that this solid complex ordinarily experiences a slow release of ClO2 gas into the air. Conditions can be selected such that the concentration level of the ClO2 released into the air is low enough to be safe (a condition suggested by the lack of conspicuous odor) but at a high enough concentration to be efficacious for disinfection and/or odor control in the air, and/or disinfection of surfaces or materials in contact with the air.

The solid complex can release ClO2 directly, via the gas phase, and/or via moisture that is present, into other substances. The solid can be admixed with such substances, such as by mixing powdered and/or granular solid complex with the other substances in powdered and/or granular form. The solid complex can be applied to a surface, such as skin and/or other material, either by “rubbing in” a sufficiently fine powder of the complex, and/or by holding the solid complex against the surface mechanically, as with a patch and/or bandage. The substance receiving the ClO2 from the complex can do so as a treatment of the substance and/or the substance can act as a secondary vehicle for the ClO2.

In some instances, the complex can impart different and/or useful reactivity/properties to ClO2. By changing its electronic and/or solvation environment, the reactivity of complexed ClO2 will almost certainly be quantitatively, and perhaps qualitatively, different.

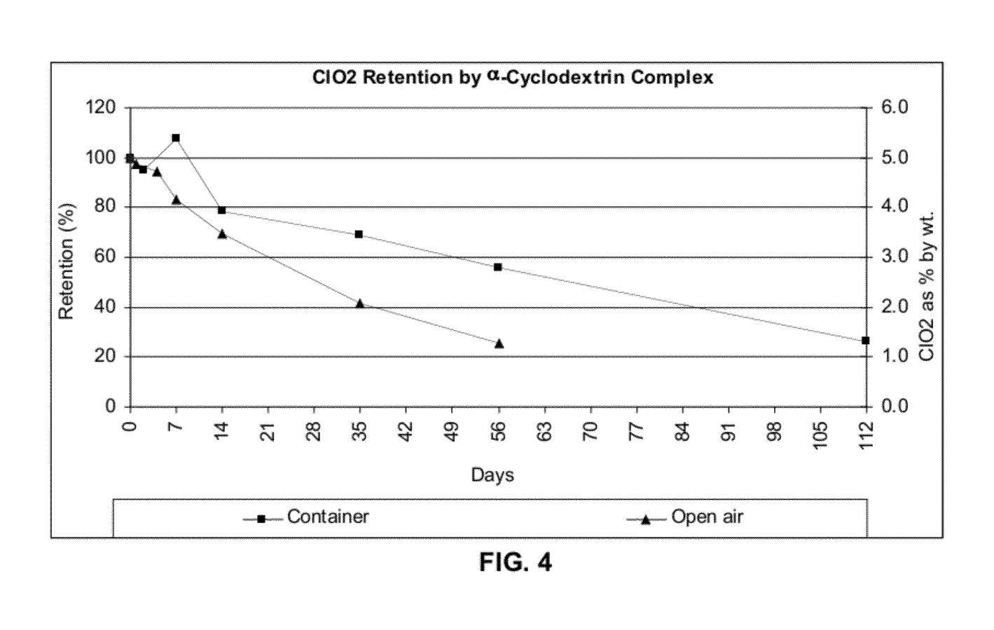

FIG. 4 illustrates the ability of an exemplary complex to retain ClO2 when stored at room temperature, either in the open air (an uncapped jar) or in a closed and/or substantially ClO2-impermeable container with relatively little headspace. It appears that ClO2 is retained somewhat more effectively in the closed, low-headspace container, and it may be possible to improve ClO2 retention further by reducing the headspace further. However, ClO2 retention is remarkable in either case, considering that the complex is an essentially waterless medium containing a reactive gaseous molecule.

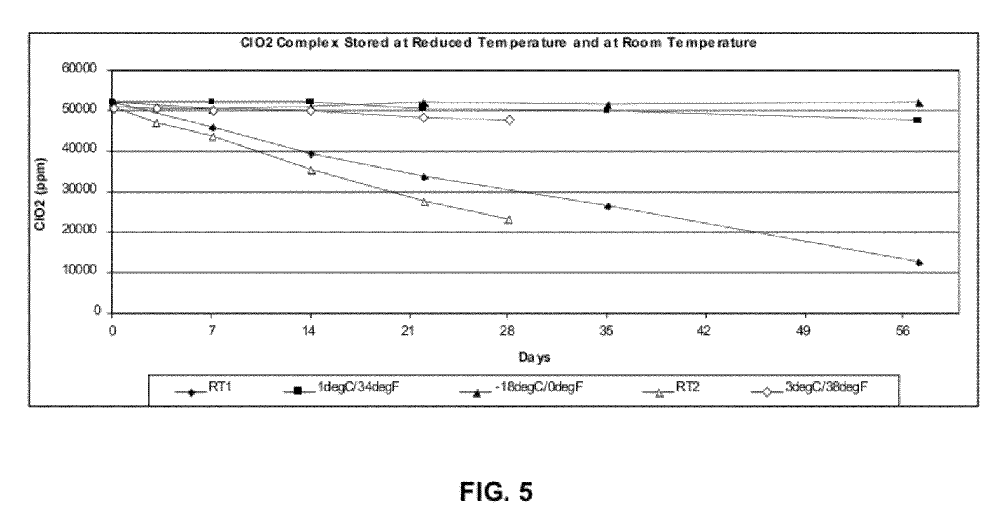

Early indications are that ClO2 retention can be greatly enhanced by cold storage. FIG. 5 illustrates retention by samples stored at room temperature (RT) (at approximately 20 C to approximately 26 C) compared to those stored in a refrigerator (at approximately 1 C and at approximately 3 C) and those stored in a freezer (at approximately −18 C). For example, to one of ordinary skill in the art, FIG. 5 illustrates that a sample stored at room temperature for 14 days, retained greater than 0 percent to greater than 65 percent, including all values and sub-ranges therebetween (e.g., 6.157, 12, 22.7, 33, 39.94, 45, etc., percent), and in fact approximately 70 percent of its original ClO2 content. Another sample, when stored at room temperature for 56 days, retained greater than 0 percent to greater than 20 percent, including all values and sub-ranges therebetween, and in fact approximately 24 percent of its original ClO2 content. As another example, FIG. 5 illustrates that a sample stored at approximately 3 C for 28 days retained greater than 0 percent to greater than 90 percent, including all values and sub-ranges therebetween, and in fact approximately 94 percent of its original ClO2 content. FIG. 5 also illustrates that a sample stored at approximately 1 C for at least 35 days retained greater than 0 percent to greater than 95 percent, including all values and sub-ranges therebetween, and in fact approximately 96 percent of its original ClO2 content. One of ordinary skill can determine additional retention amounts, percentages, and times by a cursory review of FIG. 5. While not wishing to be bound by any particular theory, these retention results might be due in part to the fact that ClO2 in the pure state, though a gas at room temperature, is a liquid at temperatures below 11 C (down to −59 C, at which temperature it freezes into a solid).

The solid complex can be packaged and/or stored in a range of forms and packages. Forms can include granulations/powders essentially as recovered from the precipitation process. The initially obtained solid complex can be further processed by grinding and/or milling into finer powder, and/or pressing into tablets and/or pucks and/or other forms known to the art. Other materials substantially unreactive toward ClO2 can be combined with the solid complex to act as fillers, extenders, binders, and/or disintegrants, etc.

Suitable packages are those that can retain gaseous ClO2 to a degree that provides acceptable overall ClO2 retention, consistent with its inherent stability, as discussed above, and/or that provide adequate protection from moisture. Suitable materials to provide high ClO2 retention can include glass, some plastics, and/or unreactive metals such as stainless steel. The final form of the product incorporating the solid complex can include any suitable means of dispensing and/or delivery, such as, for example, enclosing the solid in a dissolvable and/or permeable pouch, and/or a powder/solid metering delivery system, and/or any other means known in the art.

Other cyclodextrins: Most of the above material relates to alpha-cyclodextrin and the complex formed between it and ClO2. This is the only ClO2/cyclodextrin complex yet isolated. We believe that beta-cyclodextrin may form a complex with ClO2, which techniques readily available to us have not been able to isolate. Whereas the complex with alpha-cyclodextrin is less soluble than alpha-cyclodextrin alone, leading to ready precipitation of the complex, it may be that the ClO2/beta-cyclodextrin complex is more soluble than beta-cyclodextrin alone, making isolation more difficult. Such solubility differences are known in the art surrounding cyclodextrin complexes. Techniques such as freeze-drying may be able to isolate the complex in the future.

However indirect evidence for the complex has been observed. Beta-cyclodextrin has a known solubility in water. If the water contains a guest substance that produces a cyclodextrin complex more soluble than the cyclodextrin alone, more of the cyclodextrin will dissolve into water containing that guest than into plain water. This enhanced solubility has been observed for beta-cyclodextrin in water containing ClO2. Two separate 100 g slurries of beta-cyclodextrin solutions were prepared. The control solution contained 5% beta-cyclodextrin (w/w) in ultrapure water, and the other contained 5% beta-cyclodextrin (w/w) in 8000 ppm ClO2. Both slurries were mixed at 200 rpm for 3 days, at which time the undissolved beta-cyclodextrin was isolated from both solutions and dried for 2 days in a desiccator. The weight of the dried beta-cyclodextrin from the ClO2 containing slurry was 0.32 g less than the control slurry indicating that a soluble complex might exist between the beta-cyclodextrin and ClO2 in solution. It is believed, by extension, that ClO2 might form complexes with gamma-cyclodextrin and/or chemically derivatized versions of the natural (alpha- (“α”), beta- (“β”), and gamma- (“γ”)) cyclodextrins. In the case of beta- and/or gamma-cyclodextrin and/or other cyclodextrins having internal cavities larger than that of alpha-cyclodextrin, it might be that the complex(es) formed with ClO2 will incorporate numbers of ClO2 molecules greater than one per cyclodextrin molecule.

Related inclusion complex formers: It is expected by extension of the observed cyclodextrin complexes that some other molecules known to form inclusion compounds will also complex ClO2. In particular, cucurbiturils are molecules known primarily for having ring structures that accommodate smaller molecules into their interior cavities. These interior cavities are of roughly the same range of diameters as those of the cyclodextrins. It is anticipated that combining the appropriate cucurbituril(s) and ClO2 under correct conditions will produce cucurbituril/ClO2 complex(es), whose utility can be similar to that of cyclodextrin/ClO2 complexes.

### EXAMPLES

### Solids

### Example 1

### Solid Complex Preparation by Generation Process

ClO2 generated by the OxyChem Method II referenced above was bubbled as a stream mixed with nitrogen, at a rate of approximately 100-300 ml per minute, into an approximately 120 mL serum bottle containing approximately 100 g of approximately 11% (by weight) alpha-cyclodextrin solution at RT. Precipitation of the complex was observed to begin within approximately 1 hour, with ClO2 ultimately reaching a concentration of approximately 7000 ppm or more in the solution. Precipitation occurred very rapidly, and over the course of approximately 10 minutes enough complex was formed to occupy a significant volume of the bottle. The bottle was capped and placed in the refrigerator to facilitate further complex formation. After approximately 1 week the solid was removed from the solution onto filter paper and dried in a desiccator with Drierite for approximately 4 days. Yield was approximately 50% (by weight of starting cyclodextrin), and ClO2 concentration in the complex was approximately 1.8%.

### Examples 2-10

### Solid Complex Preparation by Combining Solutions

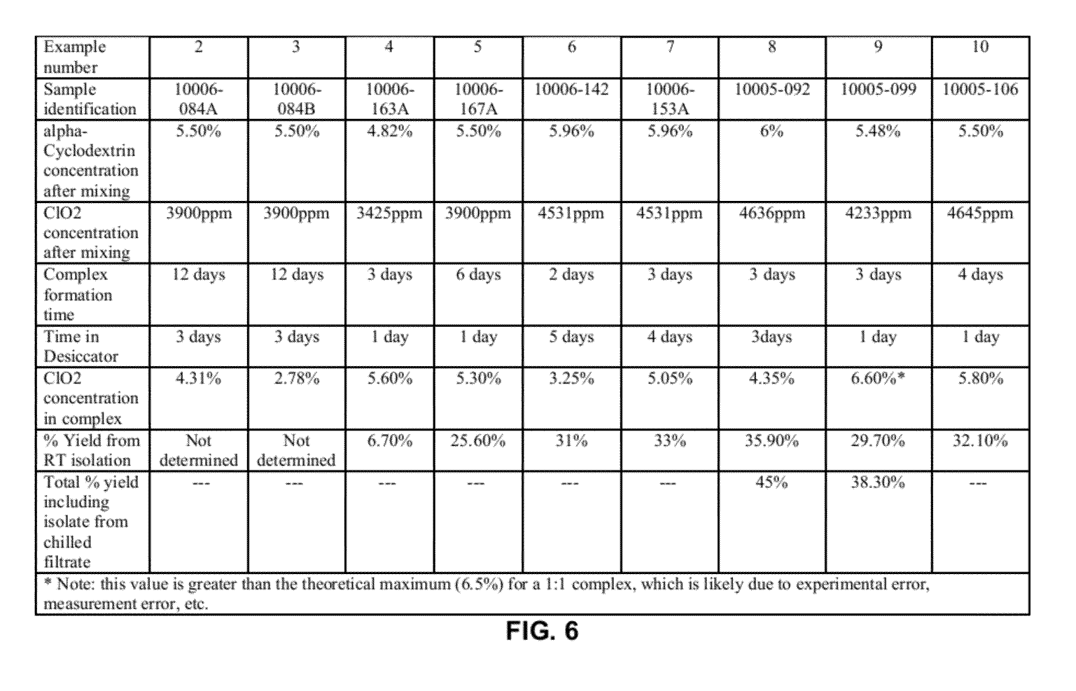

The general method used was as follows. See FIG. 6 for a table describing specifics of individual examples. A nearly saturated (approximately 11%) solution of alpha-cyclodextrin was prepared. A separate solution of ClO2 was prepared by OxyChem Method II, such that it was somewhat more concentrated than the alpha-cyclodextrin solution, on a molar basis. The two solutions were combined at approximately a 1:1 volume basis, i.e., approximately 500 ml of each, and mixed briefly to combine thoroughly. The mixture was then allowed to stand at room temperature, until the precipitate formed. Stirring during precipitation did not appear to improve the yield or quality of product. The solid was collected by filtration or decanting. In certain cases the filtrate/supernatant was chilled to facilitate formation of additional precipitate. The collected precipitate was then dried in a desiccator at ambient pressure using Drierite desiccant.

### Additional Solid Complex Examples

Other experiments showed a wide variety in initial ClO2 concentrations in freshly prepared complex. For example, in several experiments, complex formed by the combining solutions approach yielded ClO2 concentrations such as 1.8% and 0.9%. In other experiments, complex formed by the generation method in which the ClO2 was captured in an ice-chilled cyclodextrin solution yielded 0.2% ClO2.

Additional experiments at room temperature resulted in a wide variety of ClO2 retention results. For example, when complex formed by the combining solutions approach was sealed in approximately 10 ml vials with a nitrogen blanket, approximately 56% of the original ClO2 concentration was retained after 35 days, and approximately 31% was retained after 56 days. As another example, when complex formed by the generation method was left open to the air in a dark storage area, approximately 42% of the original ClO2 concentration was retained after 35 days, and approximately 25% was retained after 56 days. As yet another example, when complex formed by the generation method was sealed in approximately 10 ml clear glass vials with a nitrogen blanket and stored under white fluorescent light, approximately 13% of the original ClO2 concentration was retained after 14 days. As still another example, when complex formed by the generation method was stored in an approximately 2 ounce jar covered with Parafilm, approximately 6% of the original ClO2 concentration was retained after 59 days.

Further experiments at refrigerator temperature (approximately 1 degree C.) also resulted in a wide variety of ClO2 retention results with respect to the original ClO2 concentration, including 91% after 30 days, 95% after 85 days, and 100% after 74 days.

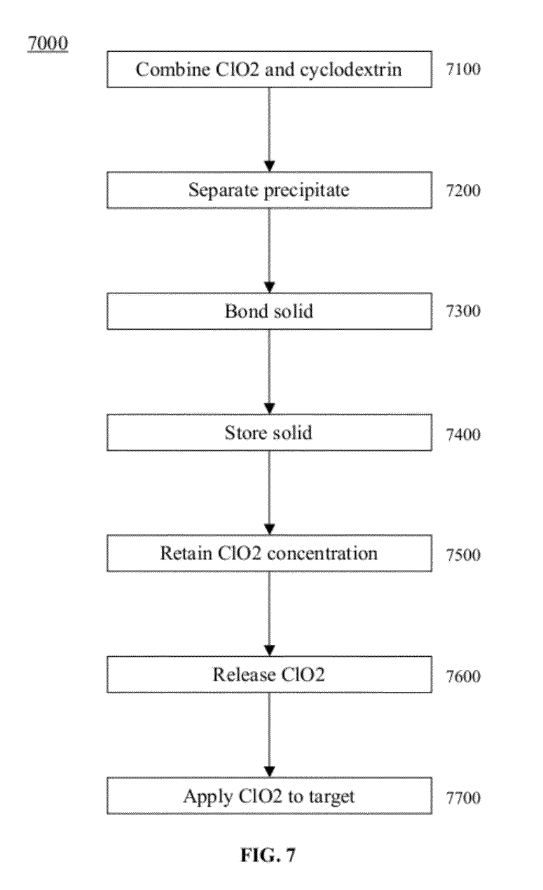

FIG. 7 is a flowchart of an exemplary embodiment of a method 7000. At activity 7100, a solution of cyclodextrin can be combined with a solution of chlorine dioxide, such as on an approximately 1:1 molar basis, to form a combined solution, which can form and/or precipitate a solid and/or solid complex comprising the chlorine dioxide complexed with the cyclodextrin. At activity 7200, the precipitate can be separated from the combined solution, and/or the combined solution and/or precipitate can be dried, lyophilized, and/or spray-dried. At activity 7300, the resulting solid complex can be bonded, such as via covalent bonding, to, for example, a substrate and/or a polymer. Bonding of the complex via the cyclodextrin to a substrate might be possible at this stage, but it might be more feasible to bond the cyclodextrin to the substrate before forming the complex with ClO2. At activity 7400, the solid complex can be stored, such as in a closed and/or substantially ClO2-impermeable container, at a desired temperature, such as at ambient, room, refrigerated, and/or heated temperature. At activity 7500, the solid complex can retain a concentration of chlorine dioxide, with respect to an initial concentration of chlorine dioxide in the complex, at, for example, greater than 60% for at least 42 days. At activity 7600, the chlorine dioxide can be released from the complex, such as by dissolving the complex in water. At activity 7700, the chlorine dioxide can be applied to a target, such as a volume of liquid, such as water, a fluid, and/or a solid, such as a surface.

### Applications for Forms of Molecular Matrix-Residing Chlorine Dioxide

There can be a need for a way of suspending growth of certain undesirable pests without using a substance that adversely affects desirable plant growth and/or the environment.

Certain exemplary embodiments can relate to a method of effectively suspending the undesirable growth of predetermined pests without harming the crop that will be planted, is planted, and/or is growing in the soil, and/or without harming the environment.

Certain exemplary embodiments can relate to a method of preventing, controlling, and/or suspending the growth of pests, such as weeds, microorganisms, pathogens, fungal diseases, insects, parasites, and/or nematodes, etc., that can cause significant damage to crops of economic interest, such as those used in total or in part for food and/or agriculture (including vegetables, fruits, berries, produce, grains, grasses, nuts, herbs, spices, tobacco, etc.), fibers (e.g., cotton, linen, soy, hemp, ramie, bamboo, kenaf, etc.), construction and/or other structural applications (e.g., timber, lumber, veneer, particleboard, etc.), and/or aesthetic, decorative, and/or ornamental purposes (such as flowers, trees, shrubs, and/or turf, etc.), etc.

Certain exemplary embodiments can relate to a method of introducing a molecular matrix-residing chlorine dioxide directly to the soil, and/or into solution that then can be introduced to the soil, in an amount sufficient to suspend growth of the pest, potentially followed by planting and/or growing a crop in the treated soil.

Certain exemplary embodiments can provide chlorine dioxide to the soil, which can serve as an effective soil fumigant and/or sterilant.

Chlorine dioxide generated directly as a gas and/or in a solution prepared from the gas (such as on-site using appropriate process equipment) can be explosive at concentrations above 10 percent or at temperatures above 130° C. (266° F.). The use of such chlorine dioxide can demand detailed attention to proper engineering controls to prevent and/or reduce exposure and/or prevent explosions, and/or the onsite generation can require specialized worker safety programs and/or closed injection systems for containment of concentrate leakage and fumes from volatilization, etc.

Yet new physical forms of ready-made and/or stable chlorine dioxide are now available, which can improve the practicality of using chlorine dioxide, such as for suspending the growth of pests. Examples of these new physical forms include a gel, such as described herein, and a solid, such as described herein, both of which are examples of what are referred to herein as “molecular matrix-residing chlorine dioxide”. It has been demonstrated that concentrations of chlorine dioxide as high as 65,000 ppm are achievable in specific executions of this approach. It should also be noted that all these new forms are essentially free of chloride, chlorite and chlorate ions based on their method of preparation. The simple appropriate dilution of these concentrates, at the point of use, forming a water based solution, can lead to the rapid dissociation (no chemical reaction) of the concentrate to yield available chlorine dioxide at the desired concentration required for effective performance, by just applying an appropriate dilution factor. Dilution of the molecular matrix-residing chlorine dioxide can be easily accomplished in the readily available and commonly found farm field mix tanks.

Certain exemplary embodiments can provide a method of growing a crop in an agricultural soil. The method can comprise diluting a molecular matrix-residing chlorine dioxide and/or introducing the resulting chlorine dioxide solution into the soil in an amount effective to suspend weed and/or pathogen growth in the soil. The chlorine dioxide solution can be allowed to decompose in the soil. A crop can be planted in the treated soil. This treatment can suspend weed and/or pathogen growth in the soil without adverse effects to the planted crop and/or with no identified negative consequences to the environment.

When provided as a gel, the molecular matrix-residing chlorine dioxides can provide chlorine dioxide concentrations of up to at least 6000 ppm. When provided as a solid, the molecular matrix-residing chlorine dioxides can have an available chlorine dioxide concentration of up to 65,000 ppm (approximately 6.5% by weight). Both the gel and the solid forms described herein are examples of dilutable molecular matrix-residing chlorine dioxides. These specific examples and/or any other crop compatible and environmentally appropriate molecular matrix-residing chlorine dioxide formulations and/or forms can be used in certain exemplary embodiments.

Prior to, during, and/or after application, any of the chlorine dioxide concentrate forms can be dissolved in and/or with water to attain a chlorine dioxide solution of a desired concentration. Because each concentrate form can comprise actual chlorine dioxide rather than precursor chemicals, the chlorine dioxide in the solutions prepared from the concentrates can be available effectively immediately, and/or with no waiting time required for the chlorine dioxide to become available. Each of the chlorine dioxide concentrates can be comprised of highly pure chlorine dioxide. Therefore there is effectively no risk of significant quantities of unreacted precursor and/or by-product chemicals being present.

Thus, the chlorine dioxide can be applied in concentrated form or diluted in an aqueous solution, wherein the chlorine dioxide content can vary between approximately 0.025% and approximately 2.5% by weight, including all values and sub-ranges therebetween. In certain exemplary embodiments, the chlorine dioxide concentration can vary between approximately 0.05% and approximately 1.5%, including all values and sub-ranges therebetween. A solution can be utilized in which the chlorine dioxide content varies between approximately 0.1% and approximately 1%, including all values and sub-ranges therebetween. In certain exemplary embodiments, soil can be treated with an aqueous solution that contains chlorine dioxide at levels of approximately 75, 175, 375, and/or 475 ppm, including all values and sub-ranges therebetween.

It has been demonstrated experimentally that the solutions prepared from the gel and from the solid have approximately the same level of antimicrobial efficacy as simple aqueous solutions of chlorine dioxide, on an equal chlorine dioxide concentration basis. As shown in the table below, a broad mixture of bacteria and fungi species derived from municipal wastewater were killed at an essentially equivalent rate by chlorine dioxide from all three sources, allowing for some inconsistencies of the method. As shown in the table, each of the three tested chlorine dioxide solutions were found to be more effective than hypochlorite bleach against bacteria, and comparable against fungi, at the same active concentration. The microbial counts were made with the use of “dip slides” (Bug Check® BF, by Avalon International Corporation of Northfield, Ill.), which are nutrient plates that are briefly dipped into the test water, then allowed to incubate under controlled conditions, for approximately 72 hours in this case, to provide plate counts of viable organisms. Counts given in the table below are based on visual comparison of the dip slides to a “conversion chart” containing standard images of dip slides reflecting specific organism counts, in “log 10” increments; i.e. 10³, 10⁴, 10⁵, etc., organisms per ml of test water.)

| Treatment | | | 72 hours | |
|---|---|---|---|---|
| | | Contact time | Bacteria/ | |
| Active agent/Form | Conc (ppm) | (min) | mL* | Fungi/mL |
| Control: wastewater diluted 1:10 (untreated) | | | 10⁶ | 10² |
| ClO2/solution | 2.5 | 0.5 | <10³ (5) | 0 |
| | | 2 | <10³ (1) | 0 |
| | | 5 | 0 | 0 |
| | | 10 | 0 | 0 |
| | | 15 | 0 | 0 |
| ClO2/solid | 2.5 | 0.5 | <10³ (\hat{ }) | 0 |
| | | 2 | 0 | 0 |
| | | 5 | 0 | 0 |
| | | 10 | 0 | 0 |
| | | 15 | 0 | 0 |
| ClO2/gel | 2.5 | 0.5 | <10³ (9) | 10¹ |
| | | 2 | 0 | 0 |
| | | 5 | <10³ (4) | 10¹ |
| | | 10 | <10³ (1) | 0 |
| | | 15 | 0 | 0 |
| Bleach/solution | 2.5 | 0.5 | 10⁵ | 0 |
| | | 2 | 10⁵ | 10¹ |
| | | 5 | 10⁵ | 10¹ |
| | | 10 | 10⁴-10⁵ | 10¹ |
| | | 15 | 10⁴-10⁵ | 0 |

*The minimum non-zero bacterial count illustrated in the Bug Check conversion chart is 10³, with intermediate counts being unreliable by this method. The conversion chart illustration for the 10³ count shows 15 spots, each spot representing a bacterial colony. In the bacterial count column of this table, numbers in parentheses are the actual observed number of colonies (spots) on the slide. For fungi, the conversion chart illustration for the 10¹ count shows only two spots.
(\hat{ }) This slide had no distinct spots, but showed some growth at the border of the slide.

Both the solid and gel molecular matrix-residing chlorine dioxidees can be suitable for packaging in water soluble pouch formats, based on, for example, SOLUBLON® PVA films (supplied by Aicello Chemical Co., Ltd). This format can allow precise unit dosing for batch solution preparation. These films have been granted “tolerance exemptions” by the US EPA. In addition, this approach can further enhance the already positive environmental and human safety profile of this material by eliminating the need to manage secondary container disposal, etc. This can be a major issue with most of the alternative treatment practices.

This dissolving of a chlorine dioxide concentrate can be performed after, just before application, and/or at some time prior to the application, consistent with correct storage conditions of the diluted solution. To maintain an efficacious concentration of chlorine dioxide best storage conditions can include containment in tightly closed vessels, protected from light, and/or avoiding excessive temperatures. The solution can contain beneficial components, such as fertilizers and/or other components to enhance the soil and/or the crops and/or plants to be grown in it, consistent with compatibility of these components with chlorine dioxide. These beneficial components can be added to the finished chlorine dioxide solution, incorporated into the dilution water before the dissolving, and/or, in some cases, incorporated into the concentrate forms before dilution.

The end-use solution of chlorine dioxide can be applied to agricultural soil at effective application rates (i.e., number of gallons per acre) through a method that can include irrigation and/or direct soil injection. The application method and/or rate can be such as to permit chlorine dioxide penetration into the soil to an effective depth. This can be achieved by irrigation at application rates that will percolate down into the soil to the desired depth, and/or by direct injection into the soil to an appropriate depth, with percolation further increasing the depth. Because of the volatile nature of chlorine dioxide, it can be beneficial to cover treated soil with a barrier material of limited permeability, such as plastic sheeting, at the time of and/or immediately after application, and/or continuing for some time thereafter to extend the contact time of chlorine dioxide with the soil. After any necessary treatment time has passed, the covering barrier material, if any, can be removed, and/or can be left in place to serve as a mulch. When chlorine dioxide in the soil has dissipated to levels that will have no adverse effect on crops, the crop plants can be planted.

The desired chlorine dioxide end-use concentration can depend on the circumstances, e.g., the pests (such as the weeds, pathogens, and/or parasites, etc.) to be suspended and/or controlled, the soil characteristics, the method of product application (i.e., through irrigation and/or injection, etc.), and/or the time over which the pests will be exposed to it, etc. End-use concentrations of chlorine dioxide in the range of approximately 75-975 ppm can be utilized. The range of achievable concentrations can be greater, e.g., for the gel, the solution concentration range can be from approximately zero ppm up to the concentration of the undiluted gel, for example approximately 6000 ppm; and, for the solid, the solution concentration range can be approximately zero through the saturation concentration of the solid, which is approximately 2500 ppm. Therefore, any concentration in this range can be achieved by the simple dilution of the molecular matrix-residing chlorine dioxidees that have been described.

FIG. 8 is a flowchart of an exemplary embodiment of a method 8000. At activity 8100, a molecular matrix-residing chlorine dioxide can be prepared, such as by being dissolved, diluted, and/or mixed with an aqueous fertilizer to form a solution. At activity 8200, the desired soil can be prepared for treatment with the molecular matrix-residing chlorine dioxide. At activity 8300, the molecular matrix-residing chlorine dioxide can be introduced, applied, injected, broadcast, and/or spread to, in, and/or on the soil. At activity 8400, the soil can be watered, if desired and/or needed. At activity 8500, the soil can be covered, such as to help retain the chlorine dioxide concentration in the soil. At activity 8600, the molecular matrix-residing chlorine dioxide and/or chlorine dioxide released therefrom can be allowed to decompose. At activity 8700, a crop can be planted in soil that has been treated with the molecular matrix-residing chlorine dioxide.

Certain exemplary embodiments can provide a method comprising:
introducing chlorine dioxide obtained from a molecular matrix-residing chlorine dioxide to soil in an amount effective to suspend pest growth in the soil;
applying a solid form of the molecular matrix-residing chlorine dioxide to a predetermined zone of the soil; applying a gel form of the molecular matrix-residing chlorine dioxide to a predetermined zone of the soil;
dissolving the molecular matrix-residing chlorine dioxide;
obtaining an aqueous solution comprising the chlorine dioxide;
from the molecular matrix-residing chlorine dioxide, forming an aqueous solution comprising the chlorine dioxide at a concentration of approximately 75 ppm to approximately 975 ppm;
forming a chlorine dioxide solution by combining the molecular matrix-residing chlorine dioxide with an aqueous solution comprising fertilizer;
directly injecting an aqueous solution comprising the chlorine dioxide into the soil at one or more depths, a maximum depth of injection determined by an expected maximum depth in the soil of roots of the predetermined crop;
applying water to the soil;
covering the soil for at least a portion of a time that the chlorine dioxide is decomposing in the soil;
planting a crop in the soil;
planting a crop in soil to which chlorine dioxide obtained from a molecular matrix-residing chlorine dioxide has been applied in an amount effective to suspend pest growth in the soil; and/or
planting a crop in the soil after the chlorine dioxide has decomposed; and/or wherein:
the molecular matrix-residing chlorine dioxide can be supplied in a water soluble unit dose package.

Certain exemplary embodiments can provide a method comprising planting a crop in soil to which chlorine dioxide obtained from a molecular matrix-residing chlorine dioxide has been applied in an amount effective to suspend pest growth in the soil.

Certain exemplary embodiments can provide a composition of matter comprising soil in contact with an amount of a molecular matrix-residing chlorine dioxide effective to suspend pest growth in the soil.

Certain exemplary embodiments can provide a device comprising a water soluble unit dose package containing an amount of a molecular matrix-residing chlorine dioxide effective to suspend pest growth in a predetermined volume of soil.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
air—the earth's atmospheric gas.
allow—to provide, let do, happen, and/or permit.
amount—a quantity.
and/or—either in conjunction with or in alternative to.
apparatus—an appliance or device for a particular purpose
apply—to place in contact with and/or close physical proximity to, to lay and/or spread on, and/or to put to use for a purpose.
approximately—about and/or nearly the same as.
aqueous—related to and/or containing water
at least—not less than.
bond—to attach and/or fasten.
by—via and/or with the use and/or help of.
can—is capable of, in at least some embodiments.
chlorine dioxide—a highly reactive oxide of chlorine with the formula ClO₂ or ClO2, it can appear as a reddish-yellow gas that crystallizes as orange crystals at −59° C., and it is a potent and useful oxidizing agent often used in water treatment and/or bleaching.
closed—having boundaries, enclosed.
combine—to join, merge, unite, mix, and/or blend.
complex—a compound comprising a reversible association of molecules, atoms, and/or ions.
composition of matter—a combination, reaction product, compound, mixture, formulation, material, and/or composite formed by a human and/or automation from two or more substances and/or elements.
compound—composed of two or more substances, parts, elements, and/or ingredients.
comprising—including but not limited to, what follows.
concentration—measure of how much of a given substance there is mixed, dissolved, contained, and/or otherwise present in and/or with another substance.
contact—to come together and/or physically touch a surface of.
contain—to restrain, hold, store, and/or keep within limits.
container—an enclosure adapted to retain a filling and having a closable opening via which a filling can be introduced. Examples of a container include a vial, syringe, bottle, flask, etc.
covalently—characterized by a combination of two or more atoms by sharing electrons so as to achieve chemical stability under the octet rule. Covalent bonds are generally stronger than other bonds.
cover—to overlay, place upon and/or over, and/or immerse.
crop—commercially desirable plants, including but not limited to those used in total or in part for food and/or agriculture (including vegetables, fruits, berries, produce, grains, grasses, nuts, herbs, spices, tobacco, etc.), fibers (e.g., cotton, linen, soy, hemp, ramie, bamboo, kenaf, etc.), construction and/or other structural applications (e.g., timber, lumber, veneer, particleboard, erosion control, etc.), and/or aesthetic, decorative, and/or ornamental purposes (such as flowers, trees, shrubs, and/or turf, etc.), etc.
cyclodextrin—any of a group of cyclic oligosaccharides, composed of 5 or more α-D-glucopyranoside units linked 1→4, as in amylose (a fragment of starch), typically obtained by the enzymatic hydrolysis and/or conversion of starch, designated α-, β-, and γ-cyclodextrins (sometimes called cycloamyloses), and used as complexing agents and in the study of enzyme action. The 5-membered macrocycle is not natural. Recently, the largest well-characterized cyclodextrin contains 32 1,4-anhydroglucopyranoside units, while as a poorly characterized mixture, even at least 150-membered cyclic oligosaccharides are also known. Typical cyclodextrins contain a number of glucose monomers ranging from six to eight units in a ring, creating a cone shape, typically denoted as: α-cyclodextrin: six-membered sugar ring molecule; β-cyclodextrin: seven sugar ring molecule; and γ-cyclodextrin: eight sugar ring molecule.
decompose—to decay, separate, and/or break down into components and/or basic elements.
deliver—to provide, carry, give forth, and/or emit.
depth—an extent, measurement, or dimension downward, backward, or inward.
device—a machine, manufacture, and/or collection thereof.
dilute—to make thinner and/or less concentrated by adding a liquid such as water.
directly—without anything in between and/or intervening.
dissolve—to make a solution of, as by mixing with a liquid and/or to pass into solution.
dry—(v) to lose and/or remove moisture from; (adj) substantially free from moisture or excess moisture; not moist; not wet.
effective—sufficient to bring about, provoke, elicit, and/or cause.
expected—predicted and/or anticipated.
fertilizer—Any of a large number of natural and synthetic materials, including manure and nitrogen, phosphorus, and potassium compounds, spread on or worked into soil to increase its capacity to support plant growth.
fluid—a liquid, slurry, vapor, gas, mist, cloud, plume, and/or foam, etc.
food grade—determined by the US Food and Drug Administration as safe for use in food.
form—(v) to construct, build, make, generate, and/or create; (n) a phase, structure, and/or appearance.
from—used to indicate a source.
further—in addition.
gel—a solid, semisolid, and/or liquid colloid system formed of a continuous and/or semicontinuous solid phase and a liquid phase (either discontinuous or continuous or mixed). In its sufficiently viscous forms, i.e., comprising a sufficiently high concentration of the colloid component, it is often identified by its outward gelatinous appearance, exhibiting properties of a solid such as plasticity, elasticity, or rigidity, such as little or no tendency to easily flow. Gels of the solid or semisolid variety are typically characterized by a physical property of the system, such as the yield point (defined as the shearing force required to result in the flow of said gel), which is a measure of the gel strength. A variety of compositions can form gels, including but not limited to: solubilized polymers, cross-linked polymers, concentrated surfactant solutions having crystalline-like properties (e.g., liquid crystal phases), organically modified and unmodified hydrous metal oxides (e.g., silica, silicates, alumina, iron, etc.), and organically modified and unmodified hydrous mixed metal oxides (e.g., clays, bentonites, synthetic aluminosilicates), etc.
greater—larger and/or more than.
growth—an increase in the number of cells comprised by a living entity.
initial—at a beginning
inject—to force or drive (a fluid) into something.
into—toward, in the direction of, and/or to the inside of
introduce—to put inside, onto, and/or into, and/or to place.
lyophilize—to dry by freezing in a high vacuum.
maximum—a greatest extent.
may—is allowed and/or permitted to, in at least some embodiments.
method—a process, procedure, and/or collection of related activities for accomplishing something.
mix—to combine (substances, elements, things, etc.) into one mass, collection, or assemblage, generally with a thorough blending of the constituents.
molar ratio—the ratio of moles of one substance to moles of another substance.
molecular matrix-residing chlorine dioxide—a gel and/or solid material that comprises chlorine dioxide, is essentially free of chloride, chlorite, and chlorate ions, and retains at least 90% (by weight) of an initial amount of the chlorine dioxide for at least 80 days when stored at or below 5 degrees C.
not—a negation of something.
obtain—to receive, get, take possession of, procure, acquire, and/or create.
onto—on top of, to a position on, and/or upon.
pest—an undesired living thing, such as a weed, microorganism, pathogen, fungal disease, insect, parasite, and/or nematode, etc.
pharmaceutical grade—determined by the US Food and Drug Administration as safe for use in drugs.
plant—(n) any of various photosynthetic, eukaryotic, multicellular organisms of the kingdom Plantae characteristically producing embryos, containing chloroplasts, having cellulose cell walls, and lacking the power of locomotion; (v) to place and/or set seeds, seedlings, and/or plants in soil to grow.
plurality—the state of being plural and/or more than one.
polymer—any of numerous natural and synthetic compounds of usually high molecular weight consisting of up to millions of repeated linked units, each a relatively light and simple molecule.
portion—a part and/or fraction of a whole.
precipitate—a substance separated in solid form and/or phase from a solution.
predetermined—established in advance.
prior—before and/or preceding in time or order.
probability—a quantitative representation of a likelihood of an occurrence.
release—to let go and/or free from something that restrains, binds, fastens, and/or holds back.
repeatedly—again and again; repetitively.
result—an outcome and/or consequence of a particular action, operation, and/or course.
retain—to restrain, keep, and/or hold.
root—an usually underground portion and/or part of a plant (e.g., an underground stem such as a rhizome, corm, or tuber) that lacks buds, leaves, or nodes and serves as support, draws minerals and water from the surrounding soil, and sometimes stores food.
said—when used in a system or device claim, an article indicating a subsequent claim term that has been previously introduced.
separate—to disunite, space, set, or keep apart and/or to be positioned intermediate to.
set—a related plurality.
soil—the top layer of the earth's surface, consisting of rock and mineral particles mixed with organic matter.
solid—neither liquid nor gaseous, but instead of definite shape and/or form.
soluble—capable of being dissolved or liquefied
solution—a substantially homogeneous molecular mixture and/or combination of two or more substances.
spray dry—to eject a liquid stream into a hot vapor stream, thereby separating a solute or suspension in the liquid as a solid and the solvent and/or remaining liquid into a vapor. The solid is usually collected in a drum or cyclone.
spread—To distribute and/or scatter over a surface.
store—to take in, hold, and/or secure.
substantially—to a great extent or degree.
substrate—an underlying layer.
supply—to make available for use.
surface—the outer boundary of an object or a material layer constituting or resembling such a boundary.
suspend—to inactivate, halt, retard, resist, and/or stop.
system—a collection of mechanisms, devices, machines, articles of manufacture, processes, data, and/or instructions, the collection designed to perform one or more specific functions.
technical grade—containing small amounts of other chemicals, hence slightly impure.
temperature—measure of the average kinetic energy of the molecules in a sample of matter, expressed in terms of units or degrees designated on a standard scale.
that—a pronoun used to indicate a thing as indicated, mentioned before, present, and/or well known.
time—a measurement of a point in a nonspatial continuum in which events occur in apparently irreversible succession from the past through the present to the future.
unit dose package—a single dose in a container.
utilize—to use and/or put into service.
via—by way of and/or utilizing.
water—a transparent, odorless, tasteless liquid containing approximately 11.188 percent hydrogen and approximately 88.812 percent oxygen, by weight, characterized by the chemical formula H₂O, and, at standard pressure (approximately 14.7 psia), freezing at approximately 32° F. or 0° C. and boiling at approximately 212° F. or 100° C.
weight—a force with which a body is attracted to Earth or another celestial body, equal to the product of the object's mass and the acceleration of gravity; and/or a factor assigned to a number in a computation, such as in determining an average, to make the number's effect on the computation reflect its importance.
when—at a time.
wherein—in regard to which; and; and/or in addition to.
which—a pronoun adapted to be used in clauses to represent a specified antecedent; and/or what one of
with respect to—in relation to.
zone—a specific area, region, and/or volume.

### Note

Still other substantially and specifically practical and useful embodiments will become readily apparent to those skilled in this art from reading the above-recited and/or herein—included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is incorporated by reference herein in its entirety to its fullest enabling extent permitted by law yet only to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves (if any), is to be regarded as illustrative in nature, and not as restrictive, and the scope of subject matter protected by any patent that issues based on this application is defined only by the claims of that patent.

What is claimed is:

1. A method comprising:
introducing chlorine dioxide obtained from a molecular matrix-residing chlorine dioxide to soil in an amount effective to suspend pest growth in the soil.

2. The method according to claim 1, further comprising:
applying a solid form of the molecular matrix-residing chlorine dioxide to a predetermined zone of the soil.

3. The method according to claim 1, further comprising:
applying a gel form of the molecular matrix-residing chlorine dioxide to a predetermined zone of the soil.

4. The method according to claim 1, further comprising:
dissolving the molecular matrix-residing chlorine dioxide.

5. The method according to claim 1, further comprising:
obtaining an aqueous solution comprising the chlorine dioxide.

6. The method according to claim 1, further comprising:
from the molecular matrix-residing chlorine dioxide, forming an aqueous solution comprising the chlorine dioxide at a concentration of approximately 75 ppm to approximately 975 ppm.

7. The method according to claim 1, further comprising:
forming a chlorine dioxide solution by combining the molecular matrix-residing chlorine dioxide with an aqueous solution comprising fertilizer.

8. The method according to claim 1, further comprising:
directly injecting an aqueous solution comprising the chlorine dioxide into the soil at one or more depths, a maximum depth of injection determined by an expected maximum depth in the soil of roots of the predetermined crop.

9. The method according to claim 1, wherein:
the molecular matrix-residing chlorine dioxide is supplied in a water soluble unit dose package.

10. The method according to claim 1, further comprising:
applying water to the soil.

11. The method according to claim 1, further comprising:
covering the soil for at least a portion of a time that the chlorine dioxide is decomposing in the soil.

12. The method according to claim 1, further comprising:
planting a crop in the soil.

13. A method comprising:
planting a crop in soil to which chlorine dioxide obtained from a molecular matrix-residing chlorine dioxide has been applied in an amount effective to suspend pest growth in the soil.

14. A composition of matter comprising:
soil in contact with an amount of a molecular matrix-residing chlorine dioxide effective to suspend pest growth in the soil.

15. A device comprising:
a water soluble unit dose package containing an amount of a molecular matrix-residing chlorine dioxide effective to suspend pest growth in a predetermined volume of soil.
